(19) United States
(12) Patent Application Publication
(10) Pub. No.: US 2002/0124407 A1
(43) Pub. Date: Sep. 12, 2002

(54) Apparatus and method for preloading a bearing using a digital interface

(76) Inventor: Jon J. Ullom, Utica, MI (US)

Correspondence Address: Thomas D. Helmholdt, Young & Basile, P.C., Suite 624, 3001 West Big Beaver Road, Troy, MI, 48084, US

(21) Appl. No.: 09/802,596

(22) Filed: Mar. 12, 2001

(51) Int. Cl. B23P 21/00

(52) U.S. Cl. 29/898.09; 29/714

(57) ABSTRACT

An apparatus and method according to the present invention actively monitors and controls the preload and rolling bearing resistance of angular contact pinion bearing sets for power distribution devices, such as axle pinion bearings, differential case bearings, power take-off units and the like. A hollow spindle is engageable with a drive flange for rotating a shaft. A central spindle is disposed coaxially with the axis of rotation of the hollow spindle and is sheathed within the hollow spindle. The central spindle has a socket engageable with a nut mounted on one end of the shaft for adjusting end play. Intermeshing gear teeth are interposed between the hollow spindle and the central spindle for driving the central spindle in rotation with the hollow spindle while allowing incremental rotation of the central spindle to adjust end play. First and second digital sensors monitor rolling drag resistance and torque applied to the nut. A control system responsive to the first and second digital sensors calculates average torque values for rolling drag resistance and nut load, and adjusts torque applied to the nut in response to the calculated average torque values.

### FIELD OF THE INVENTION

The present invention relates to an apparatus and method for setting the preload and rolling drag resistance of angular contact pinion bearing sets for power distribution devices, such as axle pinion bearings, differential case bearings, power takeoff units, transaxial transmissions, and the like.

### BACKGROUND OF THE INVENTION

Current pinion bearing preload machines and methods monitor peak torque off the rolling drag resistance via an analog signal, and complete the cycle of setting the bearing preload based on the first peak torque reading within preset limits. This method does not monitor the rolling drag torque of the pinion through a 360° revolution, and therefore does not guarantee the pinion preload setting will not fluctuate and is repeatable when the pinion is rotated through a full 360° rotation.

### SUMMARY OF THE INVENTION

The apparatus and the method according to the present invention monitors the pinion bearing preload based on a digital signal of both the rolling drag resistance and pinion clamp nut load through a full 360° rotation. The apparatus and method calculates the average rolling drag torque of the clamp load based on the digital signals. The present invention continuously rotates the pinion, while simultaneously tightening the pinion clamp nut. This allows the present invention to digitally monitor the rolling drag torque, while simultaneously monitoring and tightening the pinion clamp nut based on digital signals. The present invention completes the bearing preload cycle based on average digital readings of the pinion bearing clamp load and the final pinion nut torque value. The information can be displayed on a monitor at the workstation in the form of graphs using a standard windows driven operating system environment to plot the drag torque of the drive spindle versus time and the pinion nut torque of the driven spindle versus time for the entire process cycle. The information can be used to perform a signature analysis of the part to monitor for dirt, metal cutting chips, defective angular contact bearings, improperly inserted cups, and excessive pinion run-out conditions. The information can also be exchanged through known information exchange protocols, such as Profibus, DiviceNet, Modbus Plus, which operate on a digital signal platform, as well as conventional program logic controllers (PLC) interfaces.

The apparatus and method according to the present invention is used to set the bearing preload of at least one bearing supporting a shaft for rotation with respect to a housing. The shaft has a nut mounted on one end for adjusting end play. A drive flange is connected to the shaft. The apparatus includes a drive spindle, sometimes referred to herein as a first spindle, rotatable about an axis of rotation. The first spindle is engageable with the drive flange of the part for rotating the shaft. A driven spindle, sometimes referred to herein as a second spindle, is rotatable about an axis of rotation and includes a socket engageable with the nut of the part for adjusting end play. A first sensor digitally monitors rolling drag resistance of the shaft, while a second sensor digitally monitors torque applied to the nut. Control means is provided for calculating average torque values for rolling drag resistance and nut load. The control means is responsive to the first and second sensors and adjusts torque applied to the nut through the second spindle in response to the calculated average torque values.

The present invention automatically calibrates for each part, taking into account seal drag and spindle drag of the apparatus. The present invention adds the required torque to an average measurement reading taken over 360° of rotation. The present invention can “touch” the nut to increase bearing drag torque, if required. By way of example and not limitation, the present invention is capable of taking 12,000 samples to provide an average reading over 360° of rotation. Current devices provide bearing preload torque settings to an accuracy of plus or minus five (5) Newton-meters (Nm), while the present invention is capable of bearing preload setting accuracy in the range of plus or minus one quarter (1/4) Newton-meters (Nm).

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of an apparatus for setting bearing preload of at least one bearing according to the present invention;

FIG. 2 is a front elevation view of the apparatus illustrated in FIG. 1;

FIG. 3 is a side elevational view of the apparatus illustrated in FIG. 1;

FIG. 4 is a partial plan view of the apparatus illustrated in FIG. 1;

FIG. 5 is a detailed view of the apparatus illustrated in FIG. 2 engaging a part according to the present invention;

FIG. 6 is a simplified schematic view of a control system according to the present invention;

FIG. 7 is a simplified flow diagram illustrating the control logic of the control system according to the present invention;

FIG. 8 is a graph illustrating drag torque in Newton-meters (Nm) relative to time in milliseconds (msec) for a process cycle of the first or drive spindle according to the present invention; and

FIG. 9 is a graph illustrating pinion nut torque in Newtonmeters (Nm) relative to time in milliseconds (msec) for the same process cycle of the second or driven spindle corresponding with FIG. 8 according to the present invention.

### DESCRIPTION OF THE PREFERRED EMBODIMENT

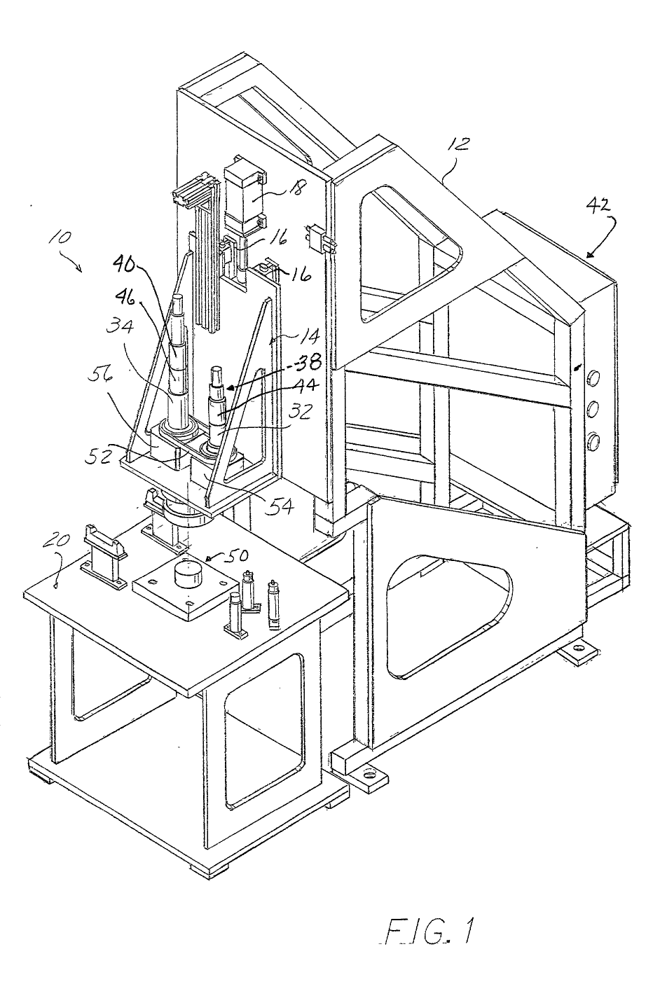

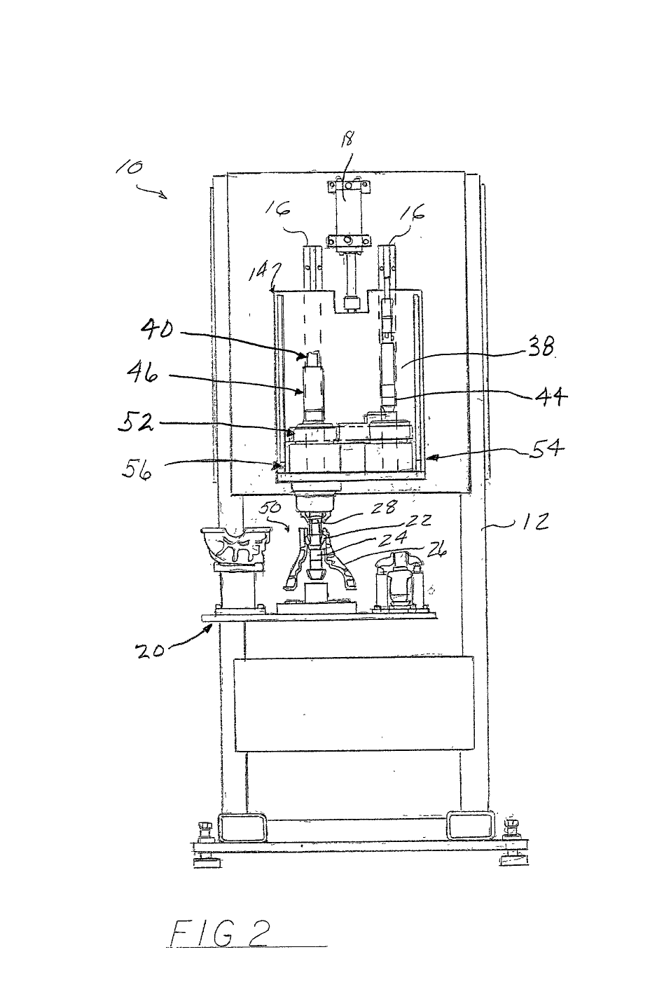

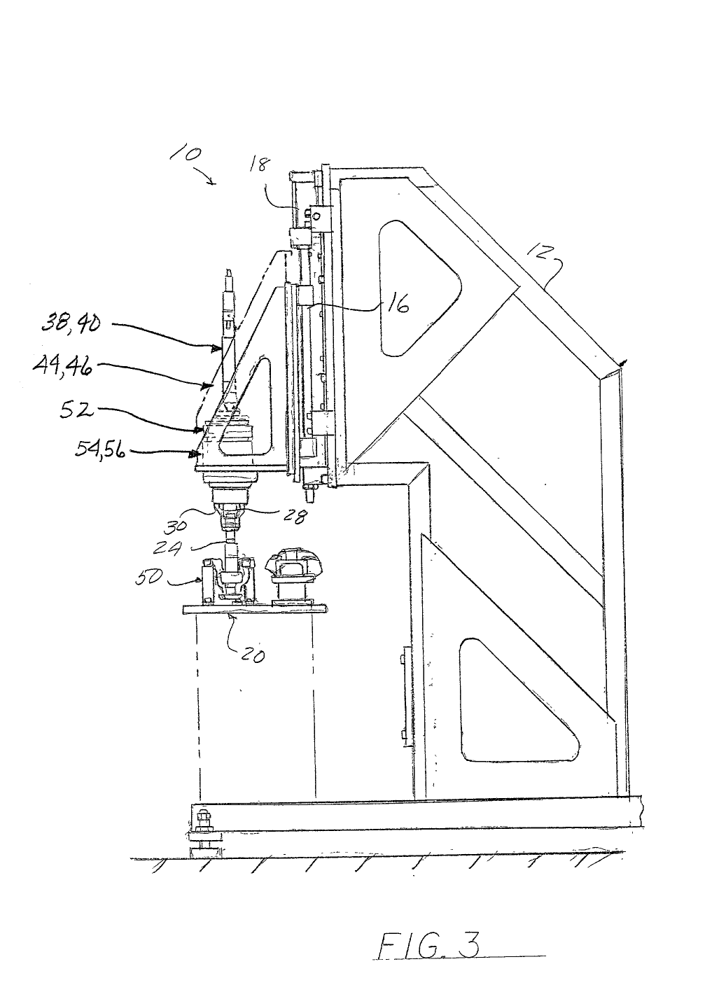

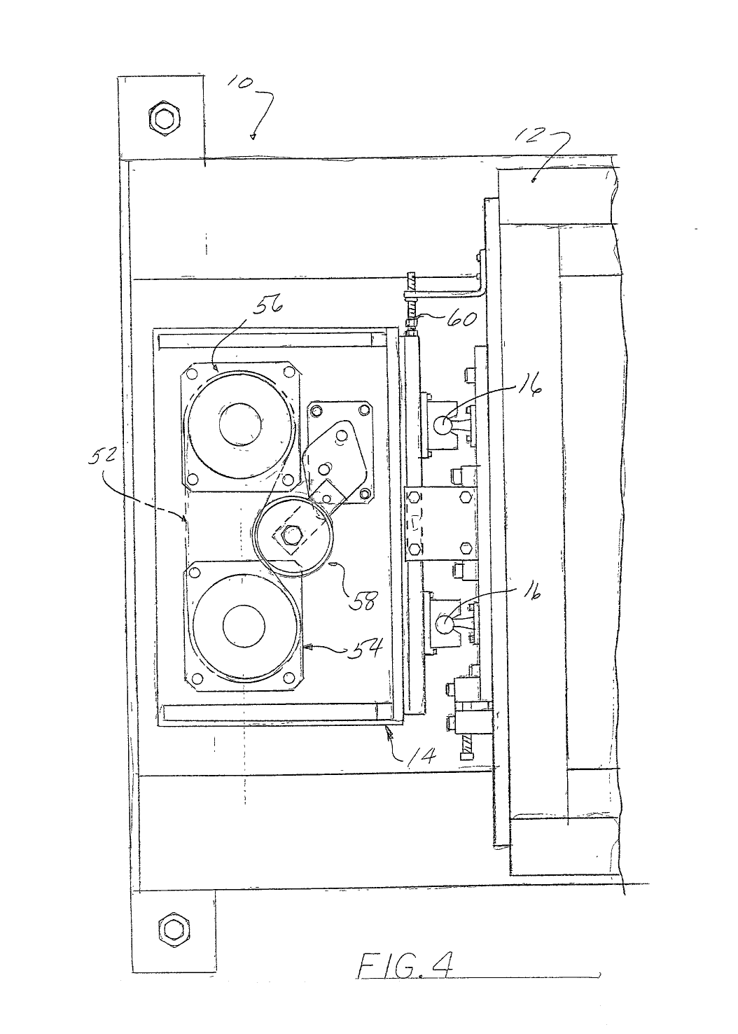

Referring now to FIGS. 1-5, an apparatus 10 according to the present invention includes a frame 12 for reciprocally supporting a carriage 14 on one or more rails 16 for movement between a raised position and a lowered position. An actuator 18 drives the carriage 14 along the rails 16 between the raised and lowered positions with respect to the frame 12. A part conveyor 20 supports parts for movement to a ready position, where a part to be processed is in an operable position with respect to the apparatus 10. The apparatus 10 according to the present invention actively monitors and controls the preload and rolling drag resistance of angular contact pinion bearing sets for power distribution devices, such as axle pinion bearings, differential case bearings, power take-off units, and the like.

The apparatus and method according to the present invention sets a bearing preload of at least one bearing 22, and preferably one bearing set, supporting a shaft 24 for rotation with respect to a housing 26. The shaft 24 has a nut 28 mounted on one end for adjusting end play. A drive flange 30 is connected to the shaft 24. A drive spindle, sometimes referred to herein as a first spindle 32, is rotatable about an axis of rotation. The drive spindle 32 is engageable with the drive flange 30 for rotating the shaft 24 in response to rotation of the first spindle 32. A driven spindle, sometimes referred to herein as a second spindle 34, is rotatable about an axis of rotation and includes a socket 36. The socket 36 is engageable with the nut 28 for adjusting end play. A first sensor 38 monitors rolling drag resistance of the shaft 24. A second sensor 40 monitors the torque applied to the nut 28. Control means 42 calculates the average torque values for rolling drag resistance and nut load in response to the first and second sensors 38, 40. The control means 42 can include a central processing unit, microprocessor, or microcontroller or any combination thereof. The control means 42 adjusts the torque applied to the nut 28 through the second spindle 34 in response to the calculated average torque values. The control means 42 compares current average torque values to predetermined target torque values to determine when a bearing preload cycle has been completed. The bearing preload cycle is complete when the current average torque values are at least equal to the predetermined target torque values.

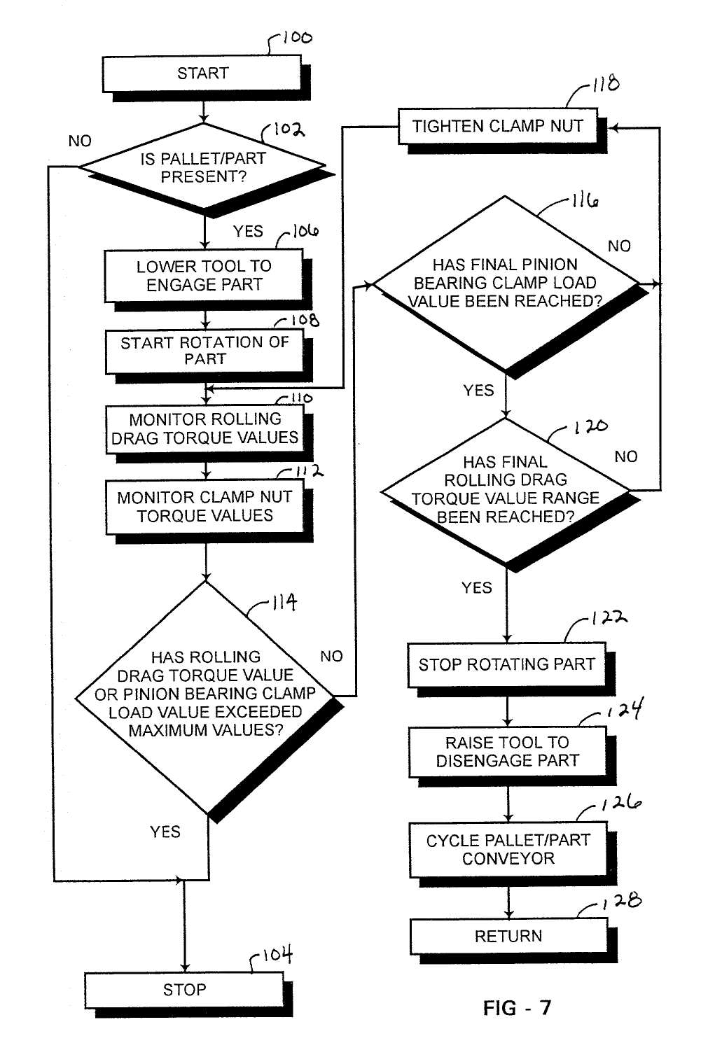

In the preferred configuration, the first sensor 38 generates and sends a first digital signal corresponding to the monitored rolling drag resistance of the shaft 24. The second sensor 40 preferably generates and sends a second digital signal corresponding to the monitored torque applied to the nut 28. The digital signals allows the control means 42 to calculate average torque values for rolling drag resistance and nut load, and to exchange information obtained from the sensors through any information exchange protocol which operates on a digital signal platform or conventional program logic control interfaces. The control means 42 operates in accordance with a control program stored in memory. A simplified flow chart of the logic control for the program is illustrated in FIG. 7. The control means 42 operates to calculate the average torque values while the shaft is rotated through at least 360° of movement.

A first motor 44 drives the first spindle 32 in rotation about an axis of rotation. A second motor 46 drives the second spindle 34 in rotation about an axis of rotation. In the preferred configuration, the first spindle 32 includes a hollow spindle rotatable about the axis of rotation, and the second spindle 34 includes a central spindle coaxial with the axis of rotation of the hollow spindle and sheathed within the hollow spindle. Preferably, intermeshing gear teeth 48 are interposed between the hollow spindle 32 and the central spindle 34 for driving the central spindle 34 in rotation with the hollow spindle 32, while allowing incremental rotation of the central spindle 34 to adjust torque applied to the nut 28 in response to being driven by the second motor 46. By way of example and not limitation, the intermeshing gear teeth 48 preferably are in the form of involute splines with 49 teeth, a diametral pitch of 20, a minor diameter of 2.350, a pressure angle of 20°, a tooth depth of 0.09 inches, a profile shift (k factor) of 0, and a tooth form of 80 stub.

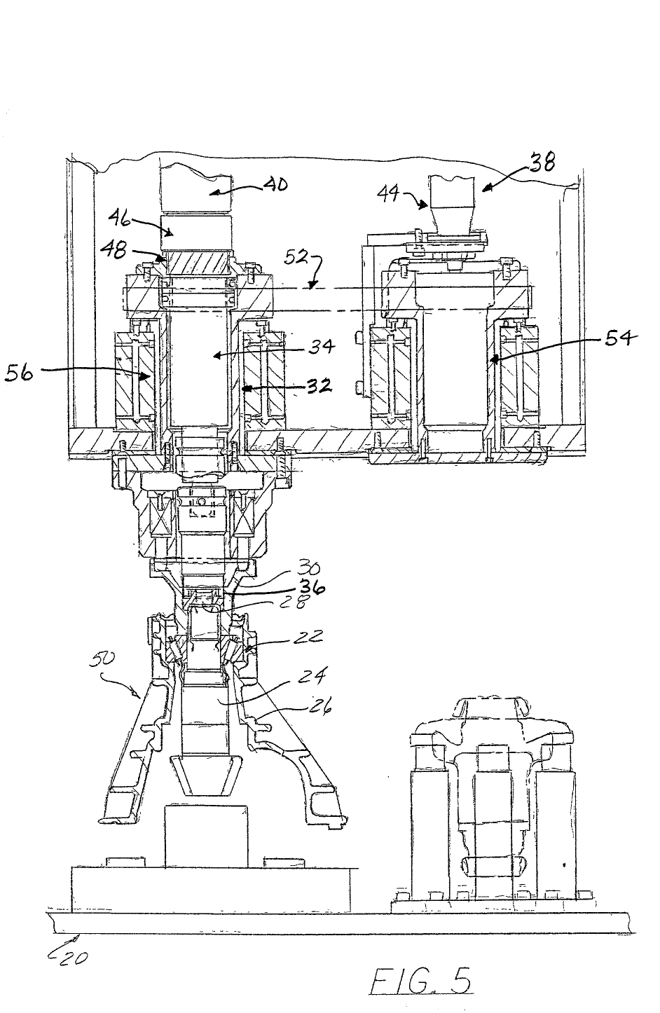

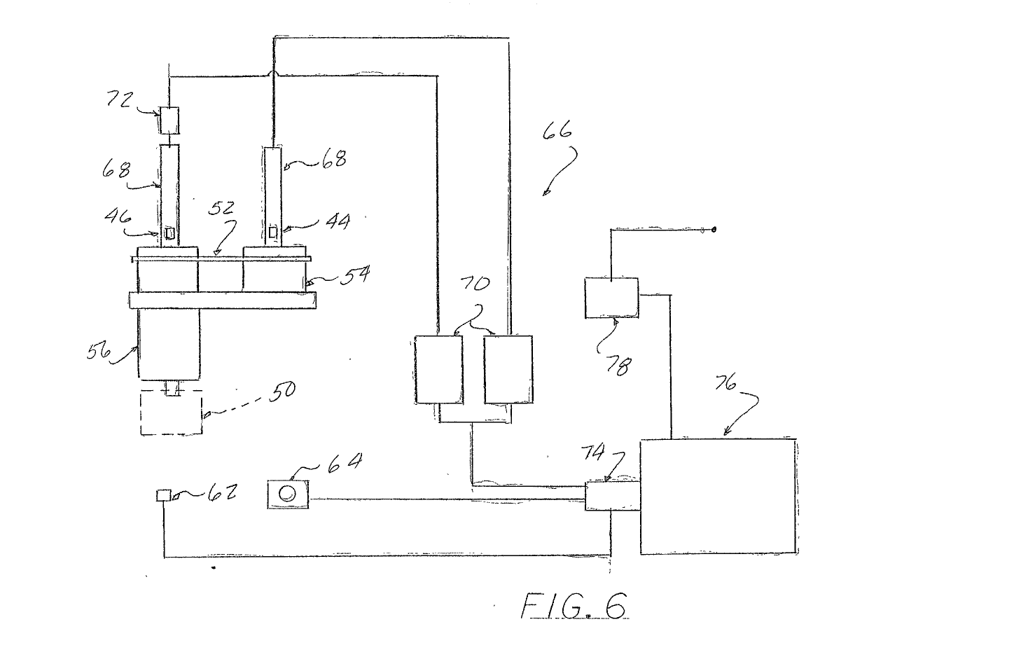

Referring now to FIG. 6, a simplified schematic diagram is illustrated showing the control system according to the present invention. A part 50 is disposed in operable engagement with the first and second tools corresponding to the tools driven by first motor 44 and the second motor 46 respectively. A drive belt 52 transfers rotation from the drive unit 54 driven by the first motor 44 to the driven unit 56 for transfer to the first spindle 32 (not shown in FIG. 6). As best seen in FIG. 5, a drive tensioner 58 is provided to act on the drive belt 52 to maintain tension in the belt for transferring rotation between the drive unit 54 and driven unit 56. A position sensor or proximity switch 60 can be provided operably positioned between the frame 12 and the carriage 14 to indicate when the carriage is in the raised position and/or the lowered position. The signal from the position sensor 60 can be sent to an appropriate control circuit, or to the control system controlling the operation of the apparatus 10.

Referring again to FIG. 6, a part/pallet-present sensor 62 can be provided for generating a signal to the control system according to the present invention to indicate whether a pallet carrying a part is present in the ready position at the apparatus 10. A remote cycle start switch 64 can be provided with appropriate interface to the control system 66 according to the present invention. One or more direct current digital transducer interfaces 68 can be provided for the first and second sensors 38, 40 for communicating the sensed conditions from the first and second sensors 38, 40 to the corresponding tool control monitors 70. A mercury wetted slip ring 72 is provided for interfacing between the second sensor 40 and the corresponding tool control monitor 70. The tool control monitors 70 can exchange information through a personal computer interface card 74 to a personal computer based controller 76. The PC based controller 76 can receive signals and generate control signals to operate the various functions of the apparatus 10. The PC based controller 76 can also interface with a machine interface 78 to control other machine functions, such as actuation of the conveyor to cycle the conveyor to remove a completed part and to deliver a new part to be processed to a ready position of the apparatus 10.

Referring now to FIG. 7, a simplified flow chart of the logic control for the apparatus 10 according to the present invention is illustrated. The flow chart begins with step 100 where the control sequence starts. The process continues to query 102 where it is determined if a pallet and/or part is present at the apparatus 10 for processing. If the pallet and/or part is not present, the control program branches to step 104 where the processing is stopped. If the pallet and part are present, the control program continues to step 106 where the carriage 14 is lowered to engage the first spindle 32 with the drive flange 30, while the socket 36 of the second spindle 34 engages with the nut 28 of the part 50 in the ready position of the apparatus 10. The process then continues to step 108 where the rotation of the shaft 24 is started in response to the first motor 44 driving the first spindle 32 through the drive belt 52 engaging drive unit 54 and driven unit 56.

While the shaft 24 is rotating, the process continues to step 110 where the first sensor 38 monitors the rolling drag torque values, and continues to step 112 where the second sensor 40 simultaneously monitors the clamp nut torque values. While the first and second sensors 38, 40 are monitoring the torque values, the process continues to query 114 where it is determined if the rolling drag torque value or the pinion bearing clamp load value have exceeded predetermined maximum values. If either torque value has exceeded a corresponding predetermined maximum value, the process branches to step 104 where the processing is stopped. If neither the rolling drag torque value or the pinion bearing clamp load value have exceeded the corresponding predetermined maximum values, the process continues to query 116 where it is determined if the final pinion bearing clamp load value has been reached. I f the final pinion bearing clamp l oad value has not been reached, the program branches to step 118 actuating the second motor 46 to drive the second spindle 34 in rotation with respect to the rotation of the first spindle 32 causing the socket 36 to tighten the nut 28. The program then returns from step 118 to continuing the monitoring steps 110 and 112 in a closed loop sequence until the final pinion bearing clamp load value has been reached or one of the maximum values have been exceeded in query 114. When the final pinion bearing clamp load value has been reached, the answer to query 116 is yes and the processing continues to query 120 where it is determined if the final rolling drag torque value range has been reached. If the final rolling drag torque value range has not been reached, the processing branches back to step 118 to tighten the clamp nut further and then returns to the monitoring steps 110 and 112 in a closed loop fashion until the final rolling drag torque value range has been reached or one of the maximum values has been exceeded in query 114. When the final rolling drag torque value range has been reached, the answer to query 120 is yes and the processing continues to step 122 where rotation of the shaft 24 is stopped.

The processing then continues to step 124 where the carriage 14 is moved to the raised position to disengage the first and second spindle 32, 34 from the part 50 at the ready position of the apparatus 10. The process then continues to step 126 where the control system cycles the pallet-part conveyor to remove the part from the ready position and to deliver a new part to the ready position for processing. The process then continues to step 128 where the processing cycle repeats from the start step 100.

The process according to the present invention tightens the clamp nut until the final pinion bearing clamp load value has been reached and the final rolling drag torque value range has been reached, or until the processing is stopped because the permissible predetermined maximum values for the rolling drag torque value or pinion bearing clamp load value have been exceeded. This method monitors the rolling drag torque of the pinion throughout at least one 360° revolution, to insure that the pinion preload setting does not fluctuate and is repeatable when the pinion is rotated through its full 360° of rotation. Preferably, the process monitors the pinion bearing preload based on a digital signal of both the rolling drag resistance and pinion clamp nut throughout a full 360° rotation, and calculates the average rolling drag torque of the clamp load. The pinion is continuously rotated while simultaneously tightening the pinion clamp nut according to the present method. This allows the process to digitally monitor the rolling drag torque, while simultaneously digitally monitoring and tightening the pinion clamp nut. The bearing preload cycle is based on average digital readings of the pinion bearing clamp load and final pinion nut torque value, rather than the first peak torque reading as previously used.

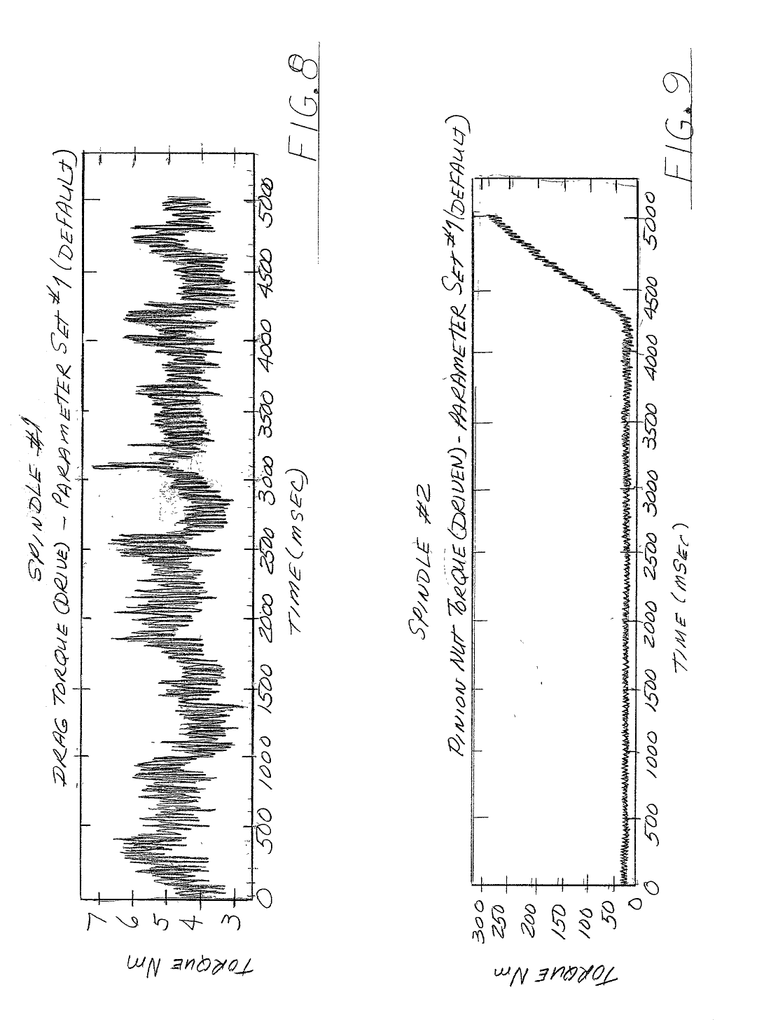

Referring now to FIGS. 8 and 9, digital information obtained during the bearing preload cycle can be displayed in graph form similar to the line illustrating the drag torque of the drive shaft shown in FIG. 8, and the line illustrating the pinion nut torque of the driven shaft shown in FIG. 9, relative to time for the entire process cycle. The information can be used to perform a signature analysis of the part to monitor for dirt, metal cutting chips, defective angular contact bearings, improperly inserted bearing cups, and excessive pinion run-out conditions. The information can also be exchanged with any information exchange protocol operating on a digital signal platform, as well as conventional program logic controller interfaces.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for setting preload of at least one bearing supporting a shaft for rotation with respect to a housing, the shaft having a nut mounted on one end for adjusting end play, and a drive flange connected to the shaft, the apparatus comprising:
a first spindle rotatable about an axis of rotation, the first spindle engageable with the drive flange for rotating the shaft;
a second spindle rotatable about an axis of rotation, the second spindle having a socket engageable with the nut for adjusting end play;
a first sensor for monitoring rolling drag resistance of the shaft;
a second sensor for monitoring torque applied to the nut; and
control means, responsive to the first and second sensors, for calculating average torque values for rolling drag resistance and nut load, and for adjusting torque applied to the nut through the second spindle in response to the calculated average torque values.

2. The apparatus of claim 1 further comprising:
the control means for comparing current average torque values to predetermined target torque values, and for completing a bearing preload cycle when the current average torque values are at least equal to the predetermined target torque values.

3. The apparatus of claim 1 further comprising:
a frame;
a carriage reciprocally support on the frame for movement between a raised position and a lowered position; and
an actuator for driving the carriage between the raised position and lowered position with respect to the frame.

4. The apparatus of claim 1 further comprising:
a part conveyor for supporting parts for movement to position a part to be adjusted in operable position with respect to the first and second spindles.

5. The apparatus of claim 1 further comprising:
the first sensor for sending a first digital signal corresponding to monitored rolling drag resistance of the shaft.

6. The apparatus of claim 1 further comprising:
the second sensor for sending a second digital signal corresponding to monitored torque applied to the nut.

7. The apparatus of claim 1 further comprising:
the control means, responsive to signals from the first and second sensors, for calculating average torque values for rolling drag resistance and nut load.

8. The apparatus of claim 1 further comprising:
the control means operating in accordance with a control program stored in memory.

9. The apparatus of claim 1 further comprising:
the control means operating while the shaft is rotated through at least 360 degrees.

10. The apparatus of claim 1 further comprising:
a first motor for driving the first spindle in rotation.

11. The apparatus of claim 1 further comprising:
a second motor for driving the second spindle in rotation.

12. The apparatus of claim 1 further comprising:
the first spindle including a hollow spindle rotatable about an axis of rotation; and
the second spindle including a central spindle coaxial with the axis of rotation of the hollow spindle and sheathed within the hollow spindle.

13. The apparatus of claim 12 further comprising:
intermeshing gear teeth interposed between the hollow spindle and the central spindle for driving the central spindle in rotation with the hollow spindle, while allowing incremental rotation of the central spindle while adjusting torque applied to the nut.

14. An apparatus for setting preload of at least one bearing supporting a shaft for rotation with respect to a housing, the shaft having a nut mounted on one end for adjusting end play, and a drive flange connected to the shaft, the apparatus comprising:
a hollow spindle for rotation about an axis of rotation, the hollow spindle engageable with drive flange for rotating the shaft;
a first motor for driving the hollow spindle in rotation;
a central spindle coaxial with the axis of rotation of the hollow spindle and sheathed within the hollow spindle, the central spindle having a socket engageable with the nut for adjusting end play;
a second motor for driving the central spindle in rotation;
intermeshing gear teeth interposed between the hollow spindle and the central spindle for driving the central spindle in rotation with the hollow spindle, while allowing incremental rotation of the central spindle in response to the second motor;
a first digital sensor for monitoring rolling drag resistance of the hollow shaft;
a second digital sensor f or monitoring torque applied to the nut; and
control means, responsive to the first and second digital sensors, for calculating average torque values for rolling drag resistance and nut load, and for adjusting torque applied to the nut through the second motor.

15. A method for setting preload of at least one bearing supporting a shaft for rotation with respect to a housing, the shaft having a nut mounted on one end for adjusting end play, and a drive flange connected to the shaft, the method comprising the steps of:
rotating a first spindle about an axis of rotation, the first spindle engageable with the drive flange for rotating the shaft;
rotating a second spindle about an axis of rotation, the second spindle having a socket engageable with the nut for adjusting end play;
monitoring rolling drag resistance of the shaft with a first sensor;
monitoring torque applied to the nut with a second sensor;
calculating average torque values for rolling drag resistance and nut load with control means, responsive to the first and second sensors; and
adjusting torque applied to the nut through the second spindle in response to the calculated average torque values.

16. The method of claim 15 further comprising the step of:
comparing current average torque values to predetermined target torque values with the control means; and
completing a bearing preload cycle when the current average torque values are at least equal to the predetermined target torque values.

17. The method of claim 15 further comprising the steps of:
reciprocally support a carriage on a frame for movement between a raised position and a lowered position; and
driving the carriage between the raised position and lowered position with respect to the frame with an actuator.

18. The method of claim 15 further comprising the step of:
supporting parts for movement with a part conveyor to position a part to be adjusted in operable position with respect to the first and second spindles.

19. The method of claim 15 further comprising the step of:
sending a first digital signal corresponding to monitored rolling drag resistance of the shaft with the first sensor.

20. The method of claim 15 further comprising the step of:
sending a second digital signal corresponding to monitored torque applied to the nut with the second sensor.

21. The method of claim 15 further comprising the step of:
calculating average torque values for rolling drag resistance and nut load with the control means in response to signals from the first and second sensors.

22. The method of claim 15 further comprising the step of:
operating the control means in accordance with a control program stored in memory.

23. The method of claim 15 further comprising the step of:
operating the control means while the shaft is rotated through at least 360 degrees.

24. The method of claim 15 further comprising the step of:
driving the first spindle in rotation with a first motor.

25. The method of claim 15 further comprising the step of:
driving the second spindle in rotation with a second motor.

26. The method of claim 15 wherein the first spindle includes a hollow spindle rotatable about an axis of rotation, and the second spindle includes a central spindle coaxial with the axis of rotation of the hollow spindle and sheathed within the hollow spindle.

27. The method of claim 26 further comprising the step of:
intermeshing gear teeth interposed between the hollow spindle and the central spindle for driving the central spindle in rotation with the hollow spindle, while allowing incremental rotation of the central spindle to adjust torque applied to the nut.

28. A method for setting preload of at least one bearing supporting a shaft for rotation with respect to a housing, the shaft having a nut mounted on one end for adjusting end play, and a drive flange connected to the shaft, the method comprising the steps of:
rotating a hollow spindle about an axis of rotation, the hollow spindle engageable with drive flange for rotating the shaft;
driving the hollow spindle in rotation with a first motor;
rotating a central spindle coaxial with the axis of rotation of the hollow spindle and sheathed within the hollow spindle, the central spindle having a socket engageable with the nut for adjusting end play;
driving the central spindle in rotation with a second motor;
intermeshing gear teeth interposed between the hollow spindle and the central spindle for driving the central spindle in rotation with the hollow spindle, while allowing incremental rotation of the central spindle in response to the second motor;
monitoring rolling drag resistance of the hollow shaft with a first digital sensor;
monitoring torque applied to the nut with a second digital sensor;
calculating average torque values for rolling drag resistance and nut load with control means in response to the first and second digital sensors; and
adjusting torque applied to the nut through the second motor with the control means in response to the calculated average torque values.
